(19) United States
(12) Patent Application Publication
(10) Pub. No.: US 2017/0332106 A1
(43) Pub. Date: Nov. 16, 2017

(54) ENCODER, DECODER AND METHOD FOR IMAGES, VIDEO AND AUDIO

(71) Applicant: GURULOGIC MICROSYSTEMS OY, Turku (FI)

(72) Inventors: Ossi KALEVO, Akaa (FI); Tuomas KARKKAINEN, Turku (FI)

(73) Assignee: GURULOGIC MICROSYSTEMS OY, Turku (FI)

(21) Appl. No.: 15/531,690

(22) PCT Filed: Dec. 9, 2015
(86) PCT No.: PCT/EP2015/025099

§ 371 Date: May 30, 2017

(30) Foreign Application Priority Data
Dec. 9, 2014 (GB) 1421883.8

(51) Int. Cl. H04N 19/85; H04N 19/186; H04N 19/182; H04N 19/593; H04N 19/17

(52) U.S. Cl. CPC H04N 19/85; H04N 19/593; H04N 19/17; H04N 19/182; H04N 19/186

(57) ABSTRACT

An encoder for encoding input data to generate corresponding encoded data is provided. The encoder includes a data partitioning arrangement for partitioning and/or combining the input data to generate one or more data portions thereof; an analyzer arrangement for analyzing one or more properties of the one or more data portions of the input data to select one or more data formats for encoding the data portions; an encoding arrangement for encoding the data portions according to the selected data formats; and a data aggregator arrangement for aggregating the encoded data portions together with header data to generate the encoded data. The header data includes information indicative of encoding data formats, and one or more source data formats, and one or more encoding methods, namely algorithms, applied to the data portions in the encoding arrangement, and the partitioning and/or combining of the input data to generate the data portions in the data partitioning arrangement.

### TECHNICAL FIELD

The present disclosure relates to encoders for encoding input data, for example to encoders for encoding input data in a lossless or a nearly lossless manner using mutually different data formats. Moreover, the present disclosure concerns methods of encoding input data, for example method of encoding input data in a lossless or a nearly lossless manner using mutually different data formats. Furthermore, the present disclosure relates to decoders for decoding encoded data generated by the aforementioned encoders. Additionally, the present disclosure concerns methods of decoding encoded data, wherein the encoded data is generated by the aforementioned encoders and the aforementioned methods. Yet additionally, the present disclosure is concerned with computer program products comprising a non-transitory computer-readable storage medium having computer-readable instructions stored thereon, the computer-readable instructions being executable by a computerized device comprising processing hardware to execute the aforesaid methods. Yet additionally, the present disclosure concerns codecs including at least one aforementioned encoder and at least one aforementioned decoder.

### BACKGROUND

Globally, amounts of data that are stored and transmitted are increasing rapidly as a function of time, and especially amounts of data transferred from or to mobile devices is increasing temporally rapidly. Due to insufficient data transfer capability, for example wireless communication bandwidth, data storage capability, for example provided via solid state memory and/or disk space, or limited power supply, for example battery capacity of mobile devices, new improved methods for compressing and decompressing data are needed.

Contemporary known data compression standards compress, for example, images and/or videos in a color format that is often suboptimal for compressing data efficiently enough. For example, PNG compresses images in an sRGB color space; contemporary RGB alone is a color model, whereas sRGB, Adobe RGB, and similar are color spaces using an RGB color model, JPEG compresses images in a YCbCr color space, and H.264/HEVC compresses videos in the YCbCr color space.

There are known implementations wherein one coding technique is able to support multiple different pixel formats, for example JPEG is able to support sub-sampling pixel formats I420/I422/1444 and 8 bit/16 bit dynamics during encoding, but there is no implementation currently available that is able to vary an employed encoding format based on properties of original data to be coded.

The original data is potentially sometimes also provided in different data formats to a given codec; for example, one implementation of JPEG encoder takes either sRGB or YCbCr input images for compression, but there is no mechanism to deliver information regarding what an original input data format was, and the encoding of JPEG is executed in the YCbCr format. The encoded JPEG data merely contains information on which data format was used during the encoding and to which data format the data is then decoded. The decoded data is optionally, if required, converted to other data formats, but the conversion is not used to recover the original input data format; instead, the conversion is executed based on a request from a given user or target device.

Reference [1] relates to an article, wherein technical performances of different color spaces to be used with JPEG encoding were researched. A study associated with reference [1] was conducted only with natural photographic images, and not in respect of graphics, text, and so forth. Therefore, a conclusion reached in reference [1] is somewhat incorrect for a case where all possible different types of input data are compressed.

Moreover, in contemporary known techniques, Discrete Cosine Transform (DCT) or wavelet transform is often used for encoding different data blocks or packets, but then their data formats are not delivered, but the encoding method for the block is delivered or known.

Reference [2] relates to a US patent document US 2011299778 A1, which describes different coding methods that are used for different contents of an image, for example JPEG/JPEG2000/GIF/PNG. However, the different contents are actually encoded separately with different compression methods within a Region-Of-Interest (ROI).

Various methods of compressing data are described in a United States patent application US2014/355689A1 (Tourapis et al.), and also in a published PCT patent application WO2013/146405A1 (KDDI et al.).

### SUMMARY

The present disclosure seeks to provide an encoder for encoding image and/or video and/or audio data in a more efficient manner.

Moreover, the present disclosure seeks to provide a method of encoding image and/or video and/or audio data in a more efficient manner.

Furthermore, the present disclosure seeks to provide a decoder for decoding encoded image and/or video and/or audio data as generated by the aforementioned encoder.

Additionally, the present disclosure seeks to provide a method of decoding encoded image and/or video and/or audio data in a more efficient manner.

A further aim of the present disclosure is to at least partially overcome at least some of the problems of the prior art, as discussed above.

In a first aspect, embodiments of the present disclosure provide an encoder for encoding input data (D1) to generate corresponding encoded data (E2); the encoder includes data processing hardware for processing the input data (D1); the encoder includes:

(i) a data partitioning arrangement for partitioning and/or combining at least a part of the input data (D1) to generate one or more data portions thereof;

(ii) an analyzer arrangement for analyzing one or more properties of the one or more data portions of the input data (D1) to select one or more data formats for encoding the one or more data portions;

(iii) an encoding arrangement for encoding the one or more data portions according to the one or more data formats as selected by the analyzer arrangement; and

(iv) a data aggregator arrangement for aggregating the encoded one or more data portions together with header data to generate the encoded data (E2).

It will be appreciated that the partitioning is implemented by splitting and/or combining parts of the input data (D1), or is implemented by using a combination of splitting and combining parts of the input data (D1). The term “partition” used later in the text is meant to refer to any of these alone or to refer to their combination.

The header data includes information indicative of encoding data format and source data format, and optionally also information indicative of original data format, together with information indicative of selecting one or more encoding methods applied to the one or more data portions in the encoding arrangement, and the partitioning at least a part of the input data (D1) to generate the one or more data portions in the data partitioning arrangement.

It will be appreciated that “header” refers, for example, to a variety of different kind of headers, such as a file header, a frame header, a view header, an image header, a channel header, a block header, a group block header, but is not limited thereto. Moreover, instead of being included in the header, at least a part of the information is optionally located elsewhere within the encoded data (E2). The term “header” used later in the text is not meant in any way to restrict the scope of claims of the present disclosure.

The “encoding data format” is the format in which a given actual encoding activity is taking place, based on which data format is most efficiently used for encoding a given data portion in question. The “source data format”, namely “input data format”, is the format in which the data is fed to be processed by the method pursuant to the invention. Moreover, the “original data format” is the natural format of the data, in which format the data in question has been initially, namely originally.

The present disclosure is of advantage in that the encoder is capable of encoding the input data (D1) more efficiently, while enabling a reconstruction of the original input data (D1) in its source data format in a lossless or a nearly lossless manner. Optionally, the format in which the input data is reconstructed in the decoder can be some other desired format, namely a “destination data format”; thus, transcoding is susceptible to being provided by embodiments of the present disclosure.

It will be appreciated that a portion to which a given specific encoding data format is applied optionally contains different blocks, for example based on later splits and/or combinations, and which information is optionally also delivered in the encoded data (E2), and to those portions different encoding methods are optionally applied with associated information.

Moreover, the encoder is operable to encode multiple different types of data and/or different data portions of the input data (D1) by employing data formats that are most efficient for the different types of data and/or the different data portions, whilst achieving a high compression ratio.

In a second aspect, embodiments of the present disclosure provide a decoder for decoding encoded data (E2) to generate corresponding decoded data (D3); the decoder includes data processing hardware for processing the encoded data (E2); the decoder includes:

(i) a header information decoding arrangement for decoding header data included in the encoded data (E2), wherein the header data includes information indicative of one or more data formats and/or information of selecting one or more encoding methods used for encoding one or more portions of the encoded data (E2) as well as one or more source data formats, and indicative of a manner in which the one or more portions of the encoded data (E2) are derived from corresponding input data (D1) by way of partitioning and/or splitting data;

(ii) a decoding arrangement for decoding the one or more portions of the encoded data (E2) according to the information included in the header data; and

(iii) a data aggregator arrangement for combining and/splitting the decoded one or more portions of the encoded data (E2) according to the information included in the header data, to generate the decoded data (D3).

It will be appreciated that the decoded data can, in addition to source data format, also be in some other desired data format, namely in a destination data format. This destination data format is the format that the data is desired to be in after decoding, and unless that format is the same as the input data format, namely source data format, of the encoder, then transcoding is required, instead of reconstructing data into its source data format.

In a third aspect, embodiments of the present disclosure provide a codec including at least one aforementioned encoder and at least one aforementioned decoder.

In a fourth aspect, embodiments of the present disclosure provide a method of encoding input data (D1) to generate corresponding encoded data (E2), via an encoder including data processing hardware, characterized in that the method includes:

(i) partitioning and/or combining at least a part of the input data (D1) to generate one or more data portions thereof;

(ii) analyzing one or more properties of the one or more data portions of the input data (D1) to select one or more data formats for encoding the one or more data portions;

(iii) encoding the one or more data portions according to the one or more data formats as selected at (ii); and

(iv) aggregating the encoded one or more data portions together with header data to generate the encoded data (E2), wherein the header data includes information indicative of one or more encoding data formats and/or information indicative of selecting one or more encoding methods applied to the one or more data portions at (iii), as well as one or more source data formats, and the partitioning of the input data (D1) to generate the one or more data portions at (i).

In a fifth aspect, embodiments of the present disclosure provide a computer program product comprising a non-transitory computer-readable storage medium having computer-readable instructions stored thereon, the computer-readable instructions being executable by a computerized device comprising processing hardware to execute the aforementioned method of encoding.

In a sixth aspect, embodiments of the present disclosure provide a method of decoding encoded data (E2) to generate corresponding decoded data (D3), via a decoder including data processing hardware, characterized in that the method includes:

(i) decoding header data included in the encoded data (E2), wherein the header data includes information indicative of one or more encoding data formats and/or information of selecting one or more encoding methods used for encoding one or more portions of the encoded data (E2), and one or more source data formats, and indicative of a manner in which the one or more portions of the encoded data (E2) are derived from corresponding input data (D1);

(ii) decoding the one or more portions of the encoded data (E2) according to the information included in the header data; and

(iii) combining and/or splitting the decoded one or more portions of the encoded data (E2) according to the information included in the header data, to generate the decoded data (D3).

In a seventh aspect, embodiments of the present disclosure provide a computer program product comprising a non-transitory computer-readable storage medium having computer-readable instructions stored thereon, the computer-readable instructions being executable by a computerized device comprising processing hardware to execute the aforementioned method of decoding.

Embodiments of the present disclosure are capable of providing an at least partial solution to the aforementioned problem, and are capable of executing an efficient and lossless image/video and/or audio compression.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and apparatus disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an encoder for encoding input data (D1) to generate corresponding encoded data (E2) and a decoder for decoding the encoded data (E2) to generate corresponding decoded data (D3), wherein the encoder and the decoder collectively form a codec, in accordance with an embodiment of the present disclosure;

FIG. 2 is a schematic illustration of the encoder and various components thereof, in accordance with an embodiment of the present disclosure;

FIG. 3 is a schematic illustration of a flow chart depicting steps of a method of encoding input data (D1) to generate corresponding encoded data (E2), in accordance with an embodiment of the present disclosure;

FIG. 4 is a schematic illustration of the decoder and various components thereof, in accordance with an embodiment of the present disclosure;

FIG. 5 is a schematic illustration of a flow chart depicting steps of a method of decoding encoded data (E2) to generate corresponding decoded data (D3), in accordance with an embodiment of the present disclosure; and

FIG. 6 is an example of how an input image is encoded, in accordance with an embodiment of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure has been disclosed, those skilled in the art would recognize that other embodiments for carrying out or practicing the present disclosure are also possible.

In a first aspect, embodiments of the present disclosure provide an encoder for encoding input data (D1) to generate corresponding encoded data (E2). The encoder includes data processing hardware for processing the input data (D1). Optionally, the data processing hardware of the encoder is implemented by employing at least one Reduced Instruction Set Computing (RISC) processor that is operable to execute program instructions as will be elucidated in detail below.

The encoder includes a data partitioning arrangement, an analyzer arrangement, an encoding arrangement, and a data aggregator arrangement.

The data partitioning arrangement is operable to partition the input data (D1) to generate one or more data portions thereof.

The analyzer arrangement is operable to analyze one or more properties of the one or more data portions of the input data (D1) to select one or more data formats for encoding the one or more data portions.

The encoding arrangement is operable to encode the one or more data portions according to the one or more data formats as selected by the analyzer arrangement.

The data aggregator arrangement is operable to aggregate the encoded one or more data portions together with header data to generate the encoded data (E2). The header data includes information indicative of encoding data format and source data format, and optionally original data format, together with information of selecting one or more encoding methods applied to the one or more data portions in the encoding arrangement, and the partitioning of the input data (D1) to generate the one or more data portions in the data partitioning arrangement. In some example cases, the encoding data format is implicit of the encoding method applied and it does not need to be expressed separately, beside the information of selecting one or more encoding methods.

According to various embodiments of the present disclosure, the aforesaid encoder can be used to encode images and/or videos in various different color spaces and/or different pixel formats, and/or to encode audios in various different audio formats.

Optionally, the encoding arrangement includes a plurality of mutually different encoding units, wherein the plurality of mutually different encoding units are operable to encode in mutually different data formats. It will be appreciated that it is beneficial for the encoder to support multiple data formats. This enables the encoder to select a most efficient data format from the multiple data formats for encoding purposes. Beneficially, different encoding methods support several different data formats and thus, for different data formats, there are always several encoding methods available. In other words, different methods are beneficially used as alternatives with different data formats, and different methods are beneficially utilized to support encoding multiple data formats.

Optionally, for achieving better performance, the encoding arrangement is operable to use parallelization for encoding the one or more data portions substantially simultaneously. In this regard, the encoding arrangement can be implemented using a Graphics Processing Unit (GPU).

It is to be noted here that the aforesaid encoder may be implemented with an electronic device or as a part of an electronic device. In an example, the electronic device may be an image and/or video capturing device that generates large quantities of image and/or video data, wherein lossless compression is desired so as to preserve fine information in the image and/or video data, whilst rendering the quantities of the image and/or video data manageable for data storage and data communication purposes. Examples of such image and/or video capturing devices include, but are not limited to, surveillance cameras, video recorders, X-ray devices, Magnetic Resonance Imaging (MRI) scanners, and ultrasound scanners.

In another example, the electronic device may be an audio capturing device that generates large quantities of audio data, wherein lossless or nearly lossless compression is desired to preserve fine information in the audio data, whilst rendering the quantities of the audio data manageable for data storage and data communication purposes, for example, for real-time streaming of music, teleconferencing, Voice over Internet Protocol (VoIP) and the like.

Furthermore, optionally, the one or more data formats correspond to at least one of: one or more color spaces, one or more pixel formats, and/or one or more audio formats. In an example, for an image and/or video, the term “data format” generally refers to a color space and/or a pixel format associated with the image and/or video. In another example, for an audio, the term “data format” generally refers to an audio format associated with the audio.

Throughout the present disclosure, the term “color space” generally refers to a specific organization of colors, which makes it possible to reproducibly represent colors in both analogue and digital representations. A color space may either be structured mathematically, for example, such as with Adobe RGB or sRGB, or be arbitrary with particular colors assigned to a set of physical color swatches and/or corresponding assigned names or numbers, for example, such as with the Pantone Matching System (PMS). Examples of color spaces include, but are not limited to, RGB, sRGB, Adobe RGB, Adobe Wide Gamut RGB, Apple RGB, ProPhoto RGB, scRGB, Rec. 709, Rec. 2020, CIE RGB, CIE XYZ, CIELUV, CIEUVW, CIELAB, YUV, YIQ, YDbDr, YPbPr, YCbCr, xvYCC, CMYK, HSV, HSL, Munsell color system, Pantone Matching System (PMS), and Natural Color System (NCS); these examples include registered trademarks. RGB and CMYK are most often used color models as a basis for different color spaces.

Throughout the present disclosure, the term “pixel format” generally pertains to dynamics and/or resolution of a given image and/or video and amount of color channels. Examples of pixel formats include, but are not limited to, RGB/BGR 8, RGB/BGR 16, RGB/BGR 24, RGB/BGR 32, RGB24, RGBA32, I444, I422, I420, J422, J420, YV16, YV12, Y8, Y16, RGB16, and Y8 and palette for 24-bit RGB24 data. Different transformations, conversions and methods are optionally used when data is to be converted from a given first data format to a given second data format, and vice versa.

It will be appreciated that image and/or video data often includes different types of data, for example, such as graphical data, photographic data and text data. Such different types of data typically have different properties, and therefore, are advantageously encoded with different data formats, or by utilizing different data formats.

Correspondingly, audio data often includes different types of data, for example, such as music and speech. Therefore, it is beneficial to encode different parts of the audio data in different audio formats. As an example, different audio formats are beneficially used for low-frequency speech and for high-quality music.

Throughout the present disclosure, the term “audio format” generally pertains to a bit rate that is used to represent audio data. A high bit rate is typically used for lossless or nearly lossless compression. Moreover, speech is typically encoded using a relatively low bit rate.

Optionally, the selection of the one or more data formats is performed in a dynamic manner. In this regard, optionally, the selection of the one or more data formats is changed as content of the input data (D1) changes. As an example, a given data format is selected for a given data portion in a manner that encoding the given data portion from the given data format is more efficient than encoding the given data portion from its source data format directly. Practical implementations of situations where the content of the input data can change are for example when coding web pages where a plurality of mutually different contents occur, such as images, video clips, text and graphics, within the very same given input data. Moreover, even if the input data were mutually essentially similar, such as an image, there potentially arises a variance in the content, for example such that part of the image is black and white and part of it is colourful. In such a case, it can be efficient to encode the different parts of the same image in different data formats based on the most efficient encoding method for the respective content/part of the image.

In an embodiment, the analyzer arrangement is operable to perform the selection of the one or more data formats which are appropriate for image and/or video and/or audio, for example via a single pass computation. Such computation is beneficially performed in a dynamic manner, wherein dynamic ranges for transcoded data are selected depending upon content present in the image and/or video and/or audio, for in a manner of a real-time computation. As elucidated later, the selection of the formats is based upon a data analysis of the image and/or video and/or audio, for example by way of spatial analysis, Fourier analysis, color spectral analysis, temporal analysis of changes in data, and so forth.

In another embodiment, the analyzer arrangement is operable to perform the selection of the one or more data formats for each data portion separately. Throughout the present disclosure, the term “data portion” generally refers to a portion of data, for example, such as a data block, a group of data blocks, a data packet, a data section, a data frame, and a data channel.

In an example wherein a data portion refers to a data block, it will be appreciated that the aforementioned encoder is implemented in conjunction with a block encoder, for example as described in a US patent document U.S. Pat. No. 8,675,731 B2, hereby incorporated by reference.

Throughout the present disclosure, the term “channel” generally refers to a certain component of an image. In some examples, the term “channel” refers to a color channel that corresponds to a range of wavelengths. As an example, in the sRGB and CMYK color spaces, a color channel typically includes spectroscopic information that is indicative of radiation intensity corresponding to a given primary color, namely red, green or blue in the sRGB color space, or cyan, magenta, yellow and black in the CMYK color space. In the YUV color space, a Y channel corresponds to luminance, while U and V channels correspond to chrominance. In the HSV color space, one channel corresponds to brightness, while other two channels correspond to colour information.

In other examples, the term “channel” refers to other channels, for example, such as metadata, text, binary data, audio channels, preview image channels, transparent image channels, an alpha channel, and channels of other views of a three-dimensional image, but are not limited thereto. Optionally, look-up-tables (LUTs) are also used to modify data values in one channel, or for combining information from multiple channels to information of one or more channels.

It is to be noted here that a given color space has a plurality of channels, wherein often at least one channel of the plurality of channels is more relevant than one or more other channels of the plurality of channels. As an example, in the YUV or YCbCr color spaces, the Y channel includes most information, and therefore, is more relevant than other channels. Thus, it is advantageous to encode the Y channel first, so as to enable more efficient channel correlation reduction. Similarly, in the sRGB color space, a G channel includes most information, and therefore, is more relevant than R and B channels.

For example, it is efficient to encode grayscale images either in the YCbCr format or in the sBGR format. In the YCbCr format, the Y channel is encoded, while the other two channels are encoded with a constant value. In the sBGR format, the G channel is encoded first, while the R and B channels are beneficially predicted or copied from the G channel.

Optionally, in this regard, the encoding arrangement of the encoder is operable to convert information in multiple different channels to at least one another multi-channel representation that is able to describe the information in a format which is more suitable for compression purposes. This potentially decreases a sum of entropy of different channels. However, the sum of entropy of the different channels can be increased, if the correlation of the information in the different channels is susceptible to being efficiently reduced by using a suitable compression technique, for example, such as a pattern matching technique with a compensation that reduces block, channel or frame correlation.

Moreover, optionally, pixel values for different color spaces are represented in an interleaved format or a planar format, for example, depending on requirements of a selected data format.

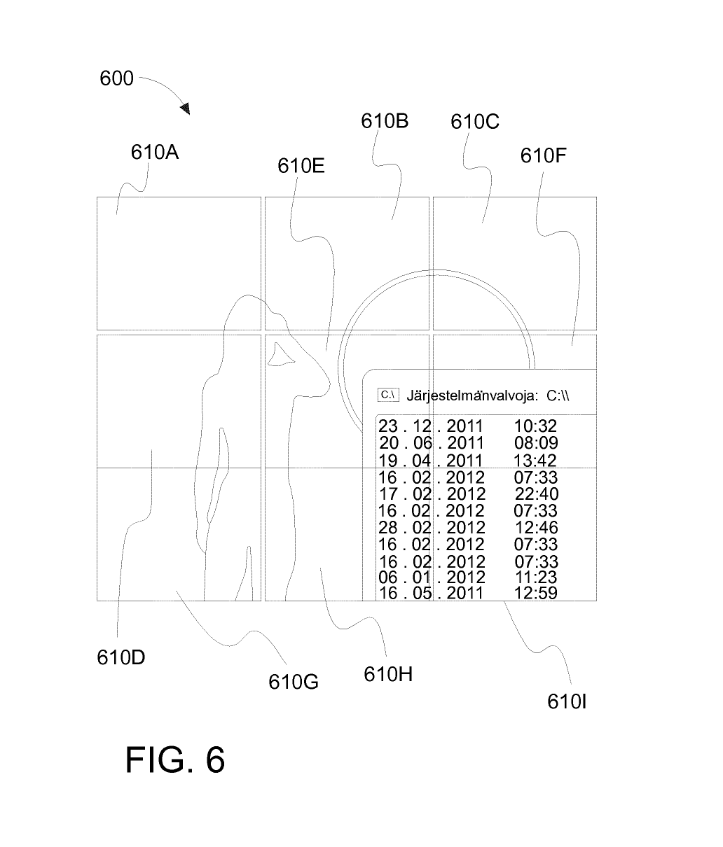

For illustration purposes only, there will now be considered an example wherein the input data (D1) includes image and/or video data, and wherein data portions of the image and/or video data are provided in a first color space and/or a first pixel format. Optionally, the analyzer arrangement is operable to select a second color space and/or a second pixel format for at least one of the data portions of the image and/or video data. Optionally, the encoding arrangement is then operable to transform the at least one of the data portions from the first color space into the second color space, and to encode the transformed at least one of the data portions from the second color space to generate the encoded at least one of the data portions, for inclusion in the encoded data (E2). In this regard, a simple example is given below in connection with FIG. 6.

Similarly, there will now be considered an example wherein the input data (D1) includes audio data, and wherein data portions of the audio data are provided in a first audio format. Optionally, the analyzer arrangement is operable to select a second audio format for at least one of the data portions of the audio data. Optionally, the encoding arrangement is then operable to transform the at least one of the data portions from the first audio format into the second audio format, and to encode the transformed at least one of the data portions from the second audio format to generate the encoded at least one of the data portions, for inclusion in the encoded data (E2). An embodiment of the present disclosure is provided, wherein audio data is quantized starting from 48 kHz 16-bit samples to generate 16 kHz 8-bit samples, for example for the purposes of coding speech data in between pieces of music, for example in a style of a radio program. In such situations, it is beneficial to encode the speech data with the sampling and dynamics specifically selected to be appropriate for speech data, instead of those required by the music data.

Optionally, the analyzer arrangement is operable to employ at least one of following methods to select the one or more data formats:

(a) a spatial Fourier analysis of image and/or video data present in the input data (D1) in one or more data formats;

(b) an audio Fourier analysis of audio data present in the input data (D1);

(c) a color information analysis of the image and/or video data present in the input data (D1) in one or more data formats;

(d) an entropy analysis of the input data (D1) in one or more data formats;

(e) a pattern matching of at least parts of the image and/or video data present in the input data (D1) to reference data in one or more data formats; and/or

(f) a rule-based analysis of the input data (D1) in one or more data formats.

Optionally, for the abovementioned pattern matching, the reference data is stored spatially locally at the encoder. Additionally or alternatively, optionally, the reference data is retrieved from a database that is spatially remote from the encoder.

Optionally, for the abovementioned entropy analysis of the input data (D1), the selection of the one or more data formats is made by computing, for example, an entropy sum of data in channels for the entire image and/or video content of the input data (D1) in multiple data formats, and selecting a data format that has a smaller entropy sum than other data formats.

Moreover, optionally, the selection of the one or more data formats takes into account a decoding quality that is desired for decoded data (D3). As an example, target devices with small display screens, for example, such as mobile phones and smart telephones, typically do not require a high decoding quality for an image and/or video that is rendered on their display screens. On the other hand, when a lossless image and/or video compression is desired, the encoding is performed in a pixel format that is similar to an original pixel format of the image and/or video data present in the input data (D1).

Moreover, optionally, the selection of the one or more data formats depends on a given target Central Processing Unit (CPU) and/or a given Graphics Processing Unit (GPU) architecture at a source. For example, Intel x86 CPU's and GPU's are often able to encode and decode faster than other types of CPU's and GPU's. As an example, Intel x86 CPU's and GPU's process floating point data better than ARM CPU's, namely a RISC computing architecture. Therefore, it is beneficial to understand an optimal capacity for each target device and differences between them. Examples of such a target device include, but are not limited to, a mobile phone, a smart telephone, a Mobile Internet Device (MID), a tablet computer, an Ultra-Mobile Personal Computer (UMPC), a phablet computer, a Personal Digital Assistant (PDA), a web pad, a Personal Computer (PC), a handheld PC, a laptop computer, a desktop computer, a large-sized touch screen with an embedded PC, and a server.

Moreover, optionally, the selection of the one or more data formats varies depending on subsampling, dynamics and so forth. Throughout the present disclosure, the term “dynamics”, namely dynamic range, generally refers to a number of bits per pixel with which a channel is expressed. For example, in the I444 pixel format for the YUV color space, there are 24 bits per pixel, namely 8 bits per pixel for each of the Y, U and V channels. Generally, the “dynamics”, namely dynamic range, means the value range into which a given value is accommodated, namely a difference between a largest value in a given range and a smallest value in the given range, and a precision to which the given value is expressed. The dynamics are optionally obtained, for example, by measuring, for example by executing an ND conversion, or by otherwise selecting and converting a value range. The more that one or more values vary, or the more precisely the variance can be expressed, the more bits (i.e. dynamics) are needed for expressing the one or more values, whether the values indicate color pixels, audio amplitude or any other value that has been obtained by measuring or by converting computations.

Moreover, optionally, a brute force method is used, if processing power capacity, time or energy consumption is not restricting the analysis. This means that, optionally, the encoding, and also decoding for lossy coding, are performed with all possible encoding formats being tried, and a best format being selected based on an amount of encoded data. A reconstruction quality of decoded data is optionally also used as a selection criteria for lossy coding. Other selection criteria are optionally based on at least one of:

(i) Fourier analysis of audio content;

(ii) spatial Fourier analysis of image and/or video data;

(iii) neural network and/or lookup table rule-based analysis, derived from previous attempts to encode image data and/or audio data; and

(iv) an analysis of entropy modification occurring in the encoded data (E2) relative to the input data (D1) as a result of different combinations of encoding methods being employed,

Moreover, optionally, the encoder further includes a data compression arrangement for compressing the encoded data (E2). Optionally, in this regard, the data compression arrangement can use different compression methods for different portions of the encoded data (E2), for example, such as entropy modifying encoding, delta encoding, ODelta encoding as defined in the US patent document U.S. Pat. No. 8,810,439 B1, range encoding, Run Length Encoding (RLE), Split RLE (SRLE) as defined in the U.S. patent document U.S. Pat. No. 8,823,560 B1, and the like.

The encoder is operable to arrange for delivery of information indicative of the one or more data formats as selected by the analyzer arrangement and one or more source data formats of the one or more data portions of the input data (D1), and optionally original data format, from the encoder to a corresponding decoder for use in subsequent decoding of the encoded data (E2). Such information is optionally included in the header data. This enables execution of an inverse of the transformation during subsequent decoding of the encoded data (E2), and potentially enables the original input data (D1) to be reconstructed in a lossless or a nearly lossless manner. Sometimes, the desired data format provided by the decoder is not the same as the input data format, and in such a case transcoding can be executed, to achieve reconstruction of the data in a desired format, namely “destination data format”.

It will be appreciated that, on account of there often being many init blocks or blocks, for which corresponding data formats are to be selected, the amount of corresponding encoding data formats delivered for them during encoding can be numerous; it is therefore beneficial to deliver them as efficiently as possible. Often, such efficient delivery means that attempts are made to combine the information about the used encoding data format, for example, with the used encoding method in case an entire given init block or block is encoded using the same method. Whereas when the encoding data format is delivered only for the init block, which is often a most efficient way to implement embodiments of the present disclosure, and the init block is then coded as one or more blocks, then it is often beneficial to combine the delivery of the encoding formats of multiple init blocks into one stream, which can then be compressed efficiently. In such a case, it is not often beneficial to combine that one piece of information regarding the encoding data format of the init block with the encoding methods of all the separate individual blocks. There is usually only one source data format in the input data, or at least there are usually fewer source data formats than there are encoding data formats. Therefore, there is usually no need to optimize the delivery of source data formats as in a case of encoding data formats. Instead, the source data format is often delivered as such, when needed. Moreover, numerical values can be issued to different data formats to enable easier delivery of data. Correspondingly, with regard to encoding methods and/or to the combinations of encoding methods and encoding data formats, there can be designated numerical values for encoding purposes, for example RGB=1, YUV=2, . . . and/or DC=1, Slide=2, DCT=3, . . . and/or DC_RGB=1, DC_YUV=2, . . .

Furthermore, optionally, the encoder is operable to communicate the encoded data (E2) to a data server and/or data storage for storing in a database. The data server and/or data storage is arranged to be accessible to a decoder, which is beneficially compatible with the encoder, for subsequently decoding the encoded data (E2).

In some examples, the decoder is optionally operable to access the encoded data (E2) from the data server and/or data storage.

In alternative examples, the encoder is optionally operable to stream the encoded data (E2) to the decoder, either via a communication network or via a direct connection. Moreover, it is to be noted that a device equipped with a hardware-based or software-based encoder can also communicate directly with another device equipped with a hardware-based or software-based decoder.

In yet other alternative examples, the decoder is optionally implemented so as to retrieve the encoded data (E2) from a non-transitory (namely non-transient) computer-readable storage medium, such as a hard drive and a Solid-State Drive (SSD).

In a second aspect, embodiments of the present disclosure provide a decoder for decoding encoded data (E2) to generate corresponding decoded data (D3). The decoder includes data processing hardware for processing the encoded data (E2). Optionally, the data processing hardware of the decoder is implemented by employing at least one RISC processor that is operable to execute program instructions as will be elucidated in detail below.

The decoder includes a header information decoder arrangement, a decoding arrangement, and a data aggregator arrangement. These are concerned essentially with processing information within the encoded data (E2), and relate to one or more issues associated with an approach which is useable for interpreting a given part of the information from the encoded data (E2). The one or more issues concern at least one of: block, device, method, format.

The header information decoder arrangement is operable to decode header data included in the encoded data (E2). The header data includes information indicative of one or more encoding data formats and/or information indicative of selecting one or more encoding methods used for encoding one or more portions of the encoded data (E2) as well as one or more source data formats, and indicative of a manner in which the one or more portions of the encoded data (E2) are derived from corresponding input data (D1), for example by way of partitioning. Additionally, optionally, the header data includes information indicative of original data formats of one or more corresponding portions in the input data (D1) from which the one or more portions of the input data (D1) are derived.

As described earlier, the one or more data formats and/or the one or more source data formats correspond to at least one of: one or more color spaces, one or more pixel formats, and/or one or more audio formats.

The decoding arrangement is operable to decode the one or more portions of the encoded data (E2) according to the information included in the header data.

When the decoder receives the information indicative of the one or more data formats that are used when data is encoded (hereinafter referred to as “encoding data formats”) and the one or more source data formats, the decoding arrangement is operable to decode the one or more portions of the encoded data (E2) by using the encoding data formats, and then to transform the decoded one or more portions back to the one or more source data formats. This potentially enables the reconstruction of the original input data (D1), namely input data format, in a lossless or a nearly lossless manner.

Optionally, the decoding arrangement includes a plurality of mutually different decoding units, wherein the plurality of mutually different decoding units are operable to decode from mutually different data formats The different data formats relate to, for example, image data, video data, audio data, but not limited thereto. For example, one data format is susceptible to being encoded with different methods, not just one method per data format. This is somethat akin to encoding ROI areas separately by using one encoding method per ROI, such as JPEG(YCbCr), PNG(sRGB). Moreover, it will be appreciated that one data partition is optionally encoded with one or more encoding methods, based on later splits or combinings executed for the data.

Moreover, optionally, the decoding arrangement is operable to use parallelization for decoding the one or more portions of the encoded data (E2) substantially simultaneously.

The data aggregator arrangement of the decoder is operable to combine the decoded one or more portions of the encoded data (E2) according to the information included in the header data, to generate the decoded data (D3).

Moreover, optionally, the decoder further includes a data decompression arrangement for decompressing the encoded data (E2).

In an embodiment, the aforementioned encoder is implemented in conjunction with methods employed for a block encoder, for example as described in a US patent document U.S. Pat. No. 8,675,731 B2, hereby incorporated by reference. In this embodiment, the aforementioned decoder is implemented in conjunction with methods employed for a block decoder, for example as described in a US patent document US 2014044191 A1.

In a third aspect, embodiments of the present disclosure provide a codec including at least one encoder for encoding input data (D1) to generate corresponding encoded data (E2), and at least one decoder for decoding the encoded data (E2) to generate corresponding decoded data (D3). The at least one encoder and the at least one decoder can be implemented as the aforementioned encoder and the aforementioned decoder, respectively.

In a fourth aspect, embodiments of the present disclosure provide a method of encoding input data (D1) to generate corresponding encoded data (E2), via an encoder including data processing hardware, characterized in that the method includes:

(i) partitioning at least a part of the input data (D1) to generate one or more data portions thereof;

(ii) analyzing one or more properties of the one or more data portions of the input data (D1) to select one or more data formats to be used for encoding the one or more data portions;

(iii) encoding the one or more data portions according to the one or more data formats as selected at (ii); and

(iv) aggregating the encoded one or more data portions together with header data to generate the encoded data (E2), wherein the header data includes information indicative of encoding data format and/or information indicative of selecting one or more encoding methods, namely algorithms, applied to the one or more data portions at (iii) as well as one or more source data formats, and the partitioning of the input data (D1) to generate the one or more data portions at (i).

Optionally, the encoded data (E2) is communicated via a plurality of channels to one or more decoders, wherein critical data, such as header information, is communicated via a higher-reliability channel and the encoded one or more data portions via one or more lower-reliability channels. Such a manner of communication is beneficial when higher-reliability channels have associated therewith a premium cost, whereas the lower-reliability channels have more modest cost, when conveying encoded data. Thus, such aggregation of data in (iv) above optionally relates to merging of data to provide the encoded data (E2) in a merged form; alternatively, such aggregation of data optionally relates to communication of the encoded data (E2) selectively via a plurality of communication channels, as aforementioned.

According to an embodiment, the method includes arranging for delivery of information indicative of the one or more data formats as selected at (ii) and one or more source data formats of the one or more data portions of the input data (D1), from the encoder to a corresponding decoder for use in subsequent decoding of the encoded data (E2).

According to an embodiment, the one or more data formats correspond to at least one of: one or more color spaces, one or more pixel formats, and/or one or more audio formats.

According to an embodiment, the method includes employing at least one of following methods to select the one or more data formats:

(a) a spatial Fourier analysis of image and/or video data present in the input data (D1) in one or more data formats;

(b) an audio Fourier analysis of audio data present in the input data (D1) in one or more data formats;

(c) a color information analysis of the image and/or video data present in the input data (D1) in one or more data formats;

(d) an entropy analysis of the input data (D1) in one or more data formats;

(e) a pattern matching of at least parts of the image and/or video data present in the input data (D1) to reference data in one or more data formats; and/or

(f) a rule-based analysis of the input data (D1) in one or more data formats.

Optionally, for the rule-based analysis, neural network computing algorithms are used to assess the one or more data portions, and then, based upon an output of the neural network algorithms, a corresponding encoding method is selected for use. Such neural network analysis is especially efficient to implement in connection with advanced quantum computing devices.

According to an embodiment, the method includes storing the reference data spatially locally at the encoder. According to another embodiment, the method includes retrieving the reference data from a database that is spatially remote from the encoder.

According to an embodiment, the method includes performing the selection of the one or more data formats in a dynamic manner; and changing the selection of the one or more data formats as content of the input data (D1) changes.

According to an embodiment, the method includes encoding the one or more data portions in mutually different data formats.

According to an embodiment, the method includes compressing the encoded data (E2).

In a fifth aspect, embodiments of the present disclosure provide a computer program product comprising a non-transitory computer-readable storage medium having computer-readable instructions stored thereon, the computer-readable instructions being executable by a computerized device comprising processing hardware to execute the aforementioned method of encoding.

In a sixth aspect, embodiments of the present disclosure provide a method of decoding encoded data (E2) to generate corresponding decoded data (D3), via a decoder including data processing hardware, characterized in that the method includes:

(i) decoding header data included in the encoded data (E2), wherein the header data includes information indicative of one or more encoding data formats and/or information indicative of selecting one or more encoding methods used for encoding one or more portions of the encoded data (E2) and one or more source data formats, and indicative of a manner in which the one or more portions of the encoded data (E2) are derived from corresponding input data (D1);

(ii) decoding the one or more portions of the encoded data (E2) according to the information included in the header data; and

(iii) combining the decoded one or more portions of the encoded data (E2) according to the information included in the header data, to generate the decoded data (D3).

According to an embodiment, the header data includes information indicative of one or more source data formats, namely input data formats, of one or more corresponding portions in the input data (D1) from which the one or more portions of the encoded data (E2) are derived.

According to an embodiment, the one or more data formats correspond to at least one of: one or more color spaces, one or more pixel formats, and/or one or more audio formats.

According to an embodiment, the method includes decoding the one or more portions of the encoded data (E2) from mutually different data formats.

According to an embodiment, the method includes decompressing the encoded data (E2).

In a seventh aspect, embodiments of the present disclosure provide a computer program product comprising a non-transitory computer-readable storage medium having computer-readable instructions stored thereon, the computer-readable instructions being executable by a computerized device comprising processing hardware to execute the aforementioned method of decoding.

Next, embodiments of the present disclosure will be described with reference to diagrams, namely figures, of the disclosure.

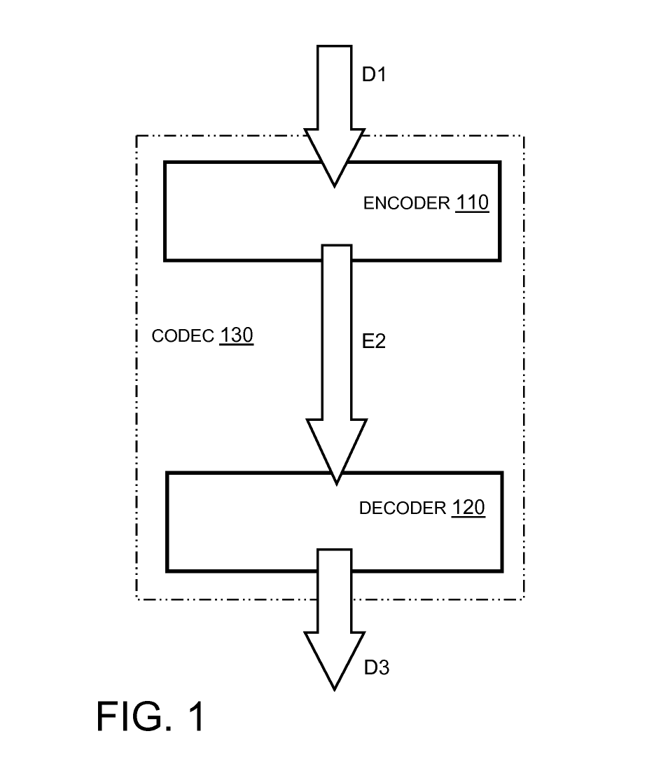

Referring to FIG. 1, embodiments of the present disclosure concern:

(i) an encoder 110 for encoding input data (D1) to generate corresponding encoded data (E2), and corresponding methods of encoding the input data (D1) to generate the corresponding encoded data (E2);

(ii) a decoder 120 for decoding the encoded data (E2) to generate corresponding decoded data (D3), and corresponding methods of decoding the encoded data (E2) to generate the corresponding decoded data (D3); and

(iii) a codec 130 including a combination of at least one encoder and at least one decoder, namely a combination of the encoder 110 and the decoder 120.

Optionally, the decoded data (D3) is exactly similar to the input data (D1), as in a lossless mode of operation. Alternatively, optionally, the decoded data (D3) is approximately similar to the input data (D1), as in a lossy mode of operation. Yet alternatively, optionally, the decoded data (D3) is different to the input data (D1), for example by way of a transformation, namely by transcoding, but retains substantially similar information present in the input data (D1); for example, the decoded data (D3) is usefully made different to the input data (D1) when reformatting of the decoded data (D3) is also required, for example to be compatible with different types of communication platforms, software layers, communication devices, and so forth. Optionally, the data can be reconstructed in the decoder to some desired data format, other than source data format, namely to a destination data format. Transcoding of the data into such a destination data format can be executed directly from the encoding data format or from the source data format. It is usually more efficient to transcode the data directly from the encoding data format but in some cases, for the purposes of the accuracy of the data or due to coding being executed only once, or only one transformation being used, the transcoding is not done until from the source data format, to which format the encoding data format is decoded to.

FIG. 1 is merely an example, which should not unduly limit the scope of the claims herein. It is to be understood that the specific designation for the codec 130 is provided as an example and is not to be construed as limiting the codec 130 to specific numbers, types, or arrangements of encoders and decoders. A person skilled in the art will recognize many variations, alternatives, and modifications of embodiments of the present disclosure

Optionally, the codec 130 is implemented within a single device. Alternatively, optionally, the codec 130 is effectively implemented between multiple devices. Optionally, the codec 130 is implemented as custom-design digital hardware, for example, via use of one or more Application-Specific Integrated Circuits (ASIC's). Alternatively, or additionally, the codec is implemented in computer software instructions executable upon processing hardware.

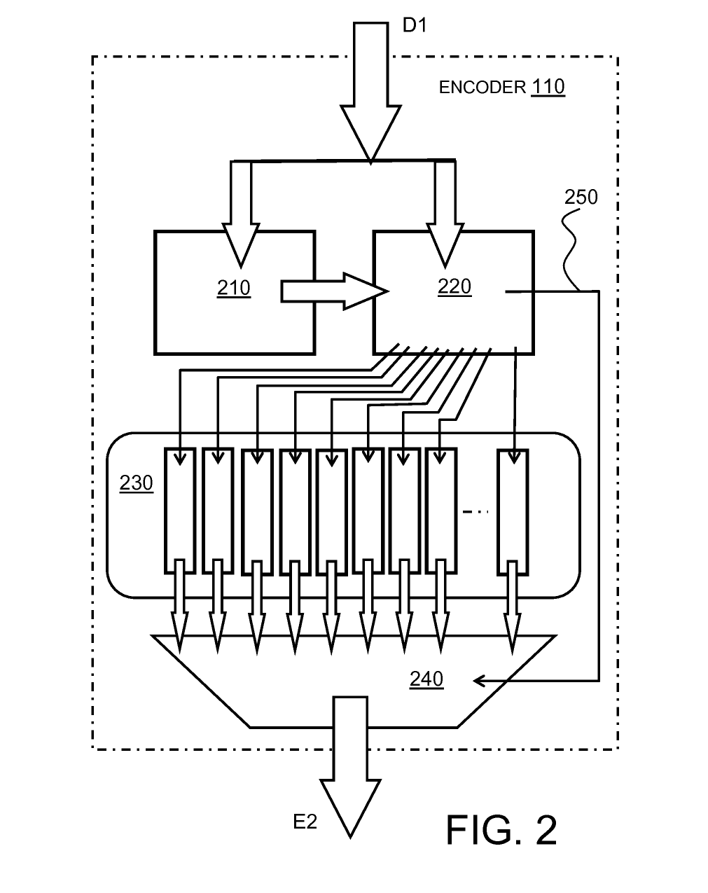

Referring now to FIG. 2, there is provided a schematic illustration of the encoder 110 and various components thereof, in accordance with an embodiment of the present disclosure. The encoder 110 includes a data partitioning arrangement 210, an analyzer arrangement 220, an encoding arrangement 230, and a data aggregator arrangement 240.

The data partitioning arrangement 210 is operable to partition at least a part of input data (D1) to generate one or more data portions thereof.

The analyzer arrangement 220 is operable to analyze one or more properties of the one or more data portions of the input data (D1) to select one or more data formats for encoding the one or more data portions, as described earlier.

The encoding arrangement 230 is operable to encode the one or more data portions with one or more encoding methods, namely algorithms, according to the one or more data formats as selected by the analyzer arrangement 220. It will be appreciated that those partitions which have been coded using different encoding formats potentially contain different encoding solutions, which again potentially utilize one or more different encoding methods, depending upon potentially later occurring splitting and/or combining. Moreover, the one or more encoding methods potentially vary arbitrarily, namely in a manner which is independent of the encoding format of the data (E2), because the possibly later occurring divisions, namely splits, are delivered from the encoder 110 to the decoder 120, as well as information which is indicative of the utilized one or more encoding methods.

Optionally, the encoding arrangement 230 is operable to use parallelization for encoding the one or more data portions substantially simultaneously, as shown in FIG. 2.

The data aggregator arrangement 240 is operable to aggregate the encoded one or more data portions together with header data to generate the encoded data (E2). As aforementioned, the header data includes information that is indicative of one or more encoding methods used for encoding data and information indicative of one or more encoding data formats, as well as information indicative of one or more data formats of the data prior to the one or more encoding methods being applied thereto.

Optionally, the analyzer arrangement 220 is operable to provide the data aggregator arrangement 240 with the header data, as depicted by an arrow 250 in FIG. 2.

FIG. 2 is merely an example, which should not unduly limit the scope of the claims herein. It is to be understood that the specific designation for the encoder 110 is provided as an example and is not to be construed as limiting the encoder 110 to specific numbers, types, or arrangements of its components. A person skilled in the art will recognize many variations, alternatives, and modifications of embodiments of the present disclosure.

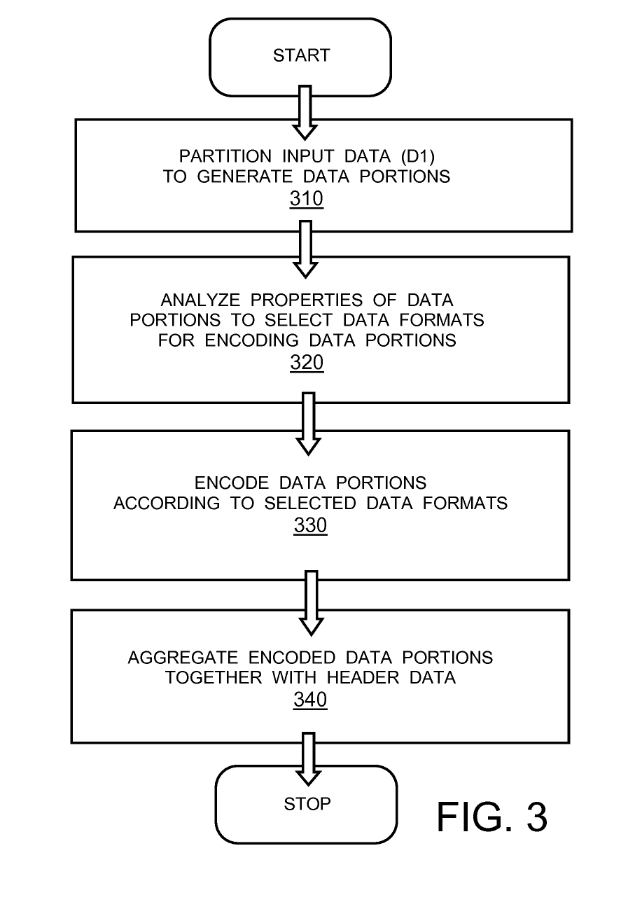

Referring now to FIG. 3, there is provided a flow chart depicting steps of a method of encoding input data (D1) to generate corresponding encoded data (E2), in accordance with an embodiment of the present disclosure. The method is depicted as a collection of steps in a logical flow diagram, which represents a sequence of steps that can be implemented in hardware, software, or a combination thereof, for example as aforementioned.

The method is implemented via an encoder including data processing hardware.

At a step 310, the input data (D1) is partitioned to generate one or more data portions thereof.

At a step 320, one or more properties of the one or more data portions of the input data (D1) are analyzed to select one or more data formats for encoding the one or more data portions.

Optionally, the step 320 is performed in a dynamic manner. In accordance with the step 320, the selection of the one or more data formats is changed as content of the input data (D1) changes. Optionally, the one or more data formats are selected based upon at least one of:

(a) a spatial Fourier analysis of image and/or video data present in the input data (D1) in one or more data formats;

(b) an audio Fourier analysis of audio data present in the input data (D1) in one or more data formats;

(c) a color information analysis of the image and/or video data present in the input data (D1) in one or more data formats;

(d) an entropy analysis of the input data (D1) in one or more data formats;

(e) a pattern matching of at least parts of the image and/or video data present in the input data (D1) to reference data in one or more data formats; and/or

(f) a rule-based analysis of the input data (D1) in one or more data formats.

Different format conversions include, for example:

(i) sRGB to YCrCb conversion;

(ii) dropping of bit amount;

(iii) scaling;

(iv) forming one or more palette out-of-color images with only a few colors. Information regarding such formats are to be found, for example, at the following contemporary Internet web sites:

http://en.wikipedia.org/wiki/Color_space#Conversion,

http://en.wikipedia.org/wiki/JPEG#Color_space_transformation,

http://en.wikipedia.org/wiki/JPEG#Downsampling,

http://en.wikipedia.org/wiki/YCbCr,

http://en.wikipedia.org/wiki/Palette_%28computing%29.

Next, at a step 330, the one or more data portions are encoded according to the one or more data formats as selected at the step 320.

At a step 340, the encoded one or more data portions are aggregated together with header data to generate the encoded data (E2). As described earlier, the header data includes information indicative of encoding applied to the one or more data portions at the step 330, namely one or more encoding data formats and/or information indicative of selecting one or more encoding methods used for encoding one or more portions of the encoded data (D2) as well as one or more source data formats and the partitioning of the input data (D1) to generate the one or more data portions at the step 310.

The steps 310 to 340 are only illustrative and other alternatives can also be provided where one or more steps are added, one or more steps are removed, or one or more steps are provided in a different sequence without departing from the scope of the claims herein. Optionally, the method includes a step of arranging for delivery of information indicative of the one or more data formats as selected at the step 320 and one or more source data formats of the one or more data portions of the input data (D1), from the encoder to a corresponding decoder for use in subsequent decoding of the encoded data (E2).

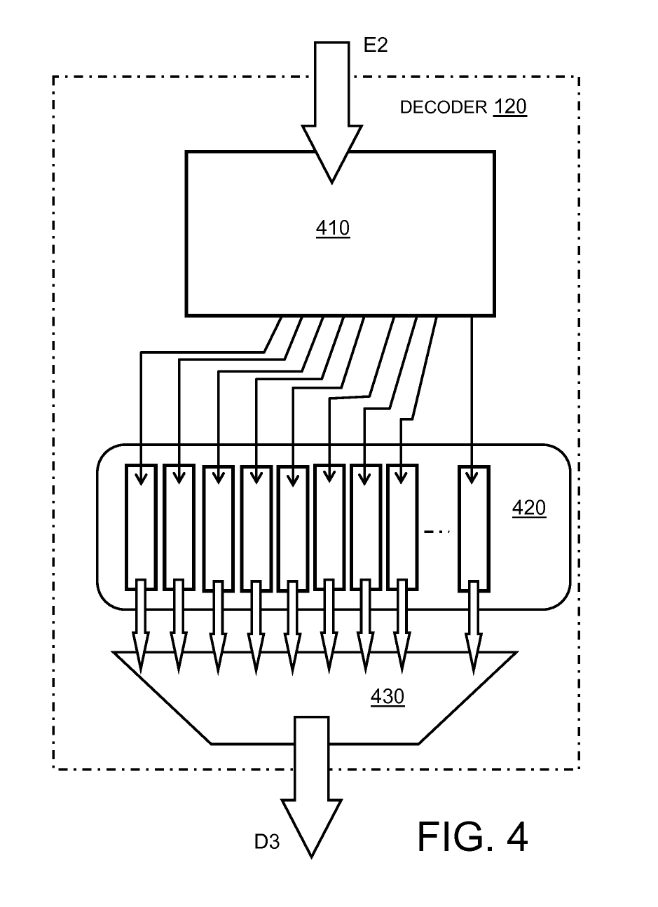

Referring next to FIG. 4, there is provided a schematic illustration of the decoder 120 and various components thereof, in accordance with an embodiment of the present disclosure. The decoder 120 includes a header information decoder arrangement 410, a decoding arrangement 420, and a data aggregator arrangement 430.

The header information decoder arrangement 410 is operable to decode header data included in the encoded data (E2). As described earlier, the header data includes information indicative of one or more encoding data formats and/or information indicative of selecting one or more encoding methods used for encoding one or more portions of the encoded data (E2) as well as one or more source data formats, and a manner in which the one or more portions of the encoded data (E2) are derived from corresponding input data (D1).

The decoding arrangement 420 is operable to decode the one or more portions of the encoded data (E2) according to the information included in the header data.

Optionally, the decoding arrangement 420 is operable to use parallelization for decoding the one or more portions of the encoded data (E2) substantially simultaneously, as shown in FIG. 4.

The data aggregator arrangement 430 is operable to combine the decoded one or more portions of the encoded data (E2) according to the information included in the header data, to generate the decoded data (D3).

FIG. 4 is merely an example, which should not unduly limit the scope of the claims herein. It is to be understood that the specific designation for the decoder 120 is provided as an example and is not to be construed as limiting the decoder 120 to specific numbers, types, or arrangements of its components. A person skilled in the art will recognize many variations, alternatives, and modifications of embodiments of the present disclosure.

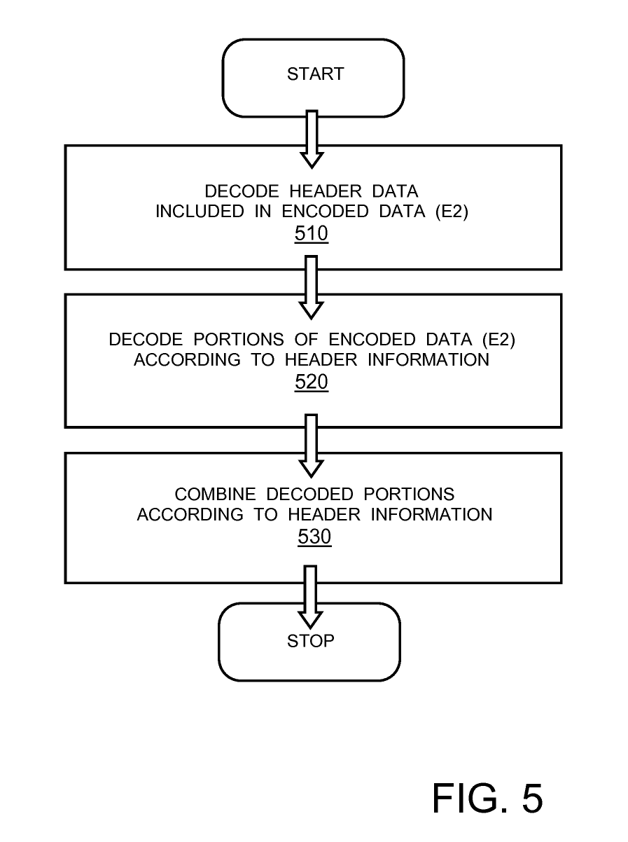

Referring now to FIG. 5, there is provided a flow chart depicting steps of a method of decoding encoded data (E2) to generate corresponding decoded data (D3), in accordance with an embodiment of the present disclosure. The method is depicted as a collection of steps in a logical flow diagram, which represents a sequence of steps that can be implemented in hardware, software, or a combination thereof, for example as aforementioned.

The method is implemented via a decoder including data processing hardware.

At a step 510, header data included in the encoded data (E2) is decoded. As described earlier, the header data includes information indicative of one or more encoding data formats and/or information indicative of selecting one or more encoding methods used for encoding one or more portions of the encoded data (E2) as well as one or more source data formats, and a manner in which the one or more portions of the encoded data (E2) are derived from corresponding input data (D1).

At a step 520, the one or more portions of the encoded data (E2) are decoded according to the information included in the header data.

At a step 530, the decoded one or more portions of the encoded data (E2) are combined according to the information included in the header data, to generate the decoded data (D3).

The steps 510 to 530 are only illustrative and other alternatives can also be provided where one or more steps are added, one or more steps are removed, or one or more steps are provided in a different sequence without departing from the scope of the claims herein.

Referring next to FIG. 6, there is provided an example of how an input image 600 is encoded, in accordance with an embodiment of the present disclosure. With reference to FIG. 6, the input image 600 is partitioned into nine data portions, namely data portions 610A, 610B, 610C, 610D, 610E, 610F, 610G, 610H and 6101 (hereinafter collectively referred to as data portions 610).

In the example, the input image 600 is provided in a first color space, for example, such as the sRGB color space. As the data portion 610I includes text data that is monochrome, it is beneficial to encode the data portion 610I with a more efficient color space, for example, such as the YUV, Y or binary and palette color space. This enables a higher compression ratio to be achieved, as compared to a case when all of the data portions 610 are compressed in the sRGB color space.

Moreover, as the data portions 610E, 610F and 610H include text data only partially, the data portions 610E, 610F and 610H can be encoded either with a source data format, namely the sRGB color space, or with any other suitable data format, for example, depending on a desired decoding quality.

FIG. 6 is merely an example, which should not unduly limit the scope of the claims herein. A person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim embodiments of the present disclosure are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

### REFERENCES

[1] Color space selection for JPEG image compression (accessed Oct. 15, 2014). URL: https://ritdml.rit.edu/handle/1850/5800

[2] Patent document US 20110299778 A1—“Method for utilizing segmentation of raster image for compression of an image”—Google Patents (accessed Oct. 15, 2014). URL: http://www.google.com/patents/US20110299778

We claim:

1. An encoder (110) for encoding input data (D1) to generate corresponding encoded data (E2), wherein the encoder (110) includes data processing hardware for processing the input data (D1), characterized in that
the encoder (110) includes:
(i) a data partitioning arrangement (210) for partitioning and/or combining at least a part of the input data (D1) to generate one or more data portions thereof;
(ii) an analyzer arrangement (220) for analyzing one or more properties of the one or more data portions of the input data (D1) to select one or more data formats for encoding the one or more data portions;
(iii) an encoding arrangement (230) for encoding the one or more data portions with one or more encoding methods according to the one or more data formats as selected by the analyzer arrangement (220); and
(iv) a data aggregator arrangement (240) for aggregating the encoded one or more data portions together with header data to generate the encoded data (E2), wherein the header data includes information indicative of one or more encoding data formats and/or information indicative of selecting one or more encoding methods applied to the one or more data portions in the encoding arrangement (230) as well as one or more source data formats, and information indicative of the partitioning and/or combining of the at least a part of the input data (D1) to generate the one or more data portions in the data partitioning arrangement (210).

2. An encoder (110) as claimed in claim 1, characterized in that information indicative of one or more original data formats for one or more portions of the input data (D1) is included in the header data.

3. An encoder (110) as claimed in claim 1 or 2, characterized in that the one or more data formats correspond to at least one of: one or more color spaces, one or more pixel formats, and/or one or more audio formats.

4. An encoder (110) as claimed in claim 1, 2 or 3, characterized in that the analyzer arrangement (220) is operable to employ at least one of following methods to select the one or more data formats:
(a) a spatial Fourier analysis of image and/or video data present in the input data (D1);
(b) an audio Fourier analysis of audio data present in the input data (D1);
(c) a color information analysis of the image and/or video data present in the input data (D1);
(d) an entropy analysis of the input data (D1);
(e) a pattern matching of at least parts of the image and/or video data present in the input data (D1) to reference data; and/or
(f) a rule-based analysis of the input data (D1).

5. An encoder (110) as claimed in claim 4, characterized in that the reference data is stored spatially locally at the encoder (110) and/or retrieved from a database that is spatially remote from the encoder (110).

6. An encoder (110) as claimed in any one or claims 1 to 5, characterized in that the selection of the one or more data formats is performed in a dynamic manner, and the selection of the one or more data formats is changed as content of the input data (D1) changes.

7. An encoder (110) as claimed in any one of claims 1 to 6, characterized in that the encoder (110) further includes a data compression arrangement for compressing the encoded data (E2).

8. An encoder (110) as claimed in any one of claims 1 to 7, characterized in that the encoding arrangement (230) includes a plurality of mutually different encoding units, wherein the plurality of mutually different encoding units are operable to encode in mutually different data formats.

9. A method of encoding input data (D1) to generate corresponding encoded data (E2), via an encoder (110) including data processing hardware, characterized in that
the method includes:
(i) partitioning and/or combining at least a part of the input data (D1) to generate one or more data portions thereof;
(ii) analyzing one or more properties of the one or more data portions of the input data (D1) to select one or more data formats for encoding the one or more data portions;
(iii) encoding the one or more data portions according to the one or more data formats as selected at (ii); and
(iv) aggregating the encoded one or more data portions together with header data to generate the encoded data (E2), wherein the header data includes information indicative of one or more encoding data formats and/or information indicative of selecting one or more encoding methods applied to the one or more data portions at (iii) as well as one or more source data formats, and information indicative of the partitioning and/or combining of the at least a part of the input data (D1) to generate the one or more data portions at (i).

10. A method as claimed in claim 9, characterized in that the one or more data formats correspond to at least one of: one or more color spaces, one or more pixel formats, and/or one or more audio formats.

11. A method as claimed in claim 9 or 10, characterized in that the method includes employing at least one of following methods to select the one or more data formats:
(a) a spatial Fourier analysis of image and/or video data present in the input data (D1);
(b) an audio Fourier analysis of audio data present in the input data (D1);
(c) a color information analysis of the image and/or video data present in the input data (D1);
(d) an entropy analysis of the input data (D1);
(e) a pattern matching of at least parts of the image and/or video data present in the input data (D1) to reference data; and/or
(f) a rule-based analysis of the input data (D1).

12. A method as claimed in claim 11, characterized in that the method includes storing the reference data spatially locally at the encoder (110) and/or retrieving the reference data from a database that is spatially remote from the encoder (110).

13. A method as claimed in any one of claims 9 to 12, characterized in that the method includes performing the selection of the one or more data formats in a dynamic manner; and changing the selection of the one or more data formats as content of the input data (D1) changes.

14. A method as claimed in any one of claims 9 to 13, characterized in that the method includes compressing the encoded data (E2).

15. A method as claimed in any one of claims 9 to 14, characterized in that the method includes encoding the one or more data portions in mutually different data formats.

16. A decoder (120) for decoding encoded data (E2) to generate corresponding decoded data (D3), wherein the decoder (120) includes data processing hardware for processing the encoded data (E2), characterized in that
the decoder (120) includes:
(i) a header information decoding arrangement (410) for decoding header data included in the encoded data (E2), wherein the header data includes information indicative of one or more encoding data formats and/or information of selecting one or more encoding methods used for encoding one or more portions of the encoded data (E2) as well as one or more source data formats, and indicative of a manner in which the one or more portions of the encoded data (E2) are derived from corresponding input data (D1);
(ii) a decoding arrangement (420) for decoding the one or more portions of the encoded data (E2) according to the information included in the header data; and
(iii) a data aggregator arrangement (430) for combining and/or partitioning the decoded one or more portions of the encoded data (E2) according to the information included in the header data, to generate the decoded data (D3).

17. A decoder (120) as claimed in claim 16, characterized in that information of one or more original data formats for one or more portions of the input data (D1) is included in the header data.

18. A decoder (120) as claimed in claim 17, characterized in that the one or more data formats correspond to at least one of: one or more color spaces, one or more pixel formats, and/or one or more audio formats.

19. A decoder (120) as claimed in any one of claims 16 to 18, characterized in that the decoder (120) further includes a data decompression arrangement for decompressing the encoded data (E2).

20. A decoder (120) as claimed in any one of claims 16 to 19, characterized in that the decoding arrangement (420) includes a plurality of mutually different decoding units, wherein the plurality of mutually different decoding units are operable to decode from mutually different data formats.

21. A method of decoding encoded data (E2) to generate corresponding decoded data (D3), via a decoder (120) including data processing hardware, characterized in that
the method includes:
(i) decoding header data included in the encoded data (E2), wherein the header data includes information indicative of one or more encoding data formats and/or information of selecting one or more encoding methods used for encoding one or more portions of the encoded data (E2) as well as one or more source data formats, and indicative of a manner in which the one or more portions of the encoded data (E2) are derived from corresponding input data (D1);
(ii) decoding the one or more portions of the encoded data (E2) according to the information included in the header data; and
(iii) combining and/or partitioning the decoded one or more portions of the encoded data (E2) according to the information included in the header data, to generate the decoded data (D3).

22. A method as claimed in claim 21, characterized in that the one or more data formats correspond to at least one of: one or more color spaces, one or more pixel formats, and/or one or more audio formats.

23. A method as claimed in claim 21 or 22, characterized in that the method includes decompressing the encoded data (E2).

24. A method as claimed in any one of claims 21 to 23, characterized in that the method includes decoding the one or more portions of the encoded data (E2) from mutually different data formats.

25. A method as claimed in any one of claims 21 to 24, characterized in that the header data includes information indicative of one or more original data formats of one or more corresponding portions in the input data (D1) from which the one or more portions of the encoded data (E2) are derived.

26. A codec (130) including at least one encoder (110) as claimed in any one of claims 1 to 8 for encoding input data (D1) to generate corresponding encoded data (E2), and at least one decoder (120) as claimed in any one of claims 16 to 20 for decoding encoded data (E2) to generate corresponding decoded data (D3).

27. A computer program product comprising a non-transitory computer-readable storage medium having computer-readable instructions stored thereon, the computer-readable instructions being executable by a computerized device comprising processing hardware to execute a method as claimed in any one of claims 9 to 15, or any one of claims 21 to 25.
